(19) United States
(12) Patent Application Publication
(10) Pub. No.: US 2020/0049797 A1
(43) Pub. Date: Feb. 13, 2020

(54) RADAR APPARATUS AND CONTROL SYSTEM

(71) Applicant: Mitsubishi Electric Corporation, Tokyo (JP)

(72) Inventor: Takeshi SUGAWARA, Tokyo (JP)

(73) Assignee: Mitsubishi Electric Corporation, Tokyo (JP)

(21) Appl. No.: 16/341,745

(22) PCT Filed: Nov. 17, 2016
(86) PCT No.: PCT/JP2016/084065

§ 371 Date: Apr. 12, 2019

(51) Int. Cl. G01S 7/36; G06F 7/58; G01S 13/34

(52) U.S. Cl. CPC G01S 7/36; G01S 13/345; G01S 13/343; G06F 7/58

(57) ABSTRACT

A computer generates a local signal using a random number sequence, and outputs the local signal (SG1). A signal generator generates and transmits a transmit signal (SG2) by frequency modulating a carrier wave with the local signal (SG1). A mixer outputs a mixer output signal (SG4) by combining the transmit signal (SG2) with a receive signal (SG3). A control filter allows the mixer output signal (SG4) to pass therethrough according to a filter control signal (SG7). The computer generates the filter control signal (SG7) using the random number sequence indicating the random number sequence used for modulation of the local signal, and outputs the filter control signal to the control filter. The computer determines whether there is an attack, based on the random number sequence and a detection signal (SG8) outputted by the control filter according to the filter control signal (SG7).

### TECHNICAL FIELD

The present invention relates to a radar apparatus that uses a frequency modulated continuous wave.

### BACKGROUND ART

A radar is an apparatus that measures a relative distance or a relative velocity between the radar and an object by irradiating the object with a radio wave and measuring a received wave having been reflected and returned. A frequency modulated continuous wave (FMCW) scheme is one of radar schemes, and has excellent distance and velocity measurement capabilities while being low in cost.

In the radar, deception may become a threat. The deception as referred to here indicates an attack that provides a wrong measured value by inserting a radio wave that pretends to be a reflected wave into the radar from an external source. Non Patent Literature 1 discloses a technique and measures for/against deception against a radar.

In recent years, attention has started to focus on deception attacks on an FMCW radar, and the results of academic research about the possibility of deception have been released. Non Patent Literature 2 discloses the fact that deception of a distance and a velocity is possible in a millimeter-wave radar of the FMCW scheme, together with experimental results.

The FMCW radar may be used for automatic operation for automobiles, etc. In that case, damage that can be caused by deception is tremendous.

### CITATION LIST

### Non Patent Literature

Non Patent Literature 1: By David Adamy, translated by Haruko Kawahigashi, et al., “A First Course in Electronic Warfare”, Tokyo Denki University Press, ISBN978-4501329402.

Non Patent Literature 2: RUCHIR CHAUHAN, “A Platform for False Data Injection in Frequency Modulated Continuous Wave Radar”, DigitalCommons, Utah State University, http://digitalcommons.usu.edu/cgi/viewcontent.cgi?article=4983&context=etd

### SUMMARY OF INVENTION

### Technical Problem

In a radar of the FMCW scheme, an attack (deception) that deceives a measured distance value by means for providing a radio wave that pretends to be a reflected wave from an external source is a threat.

A problem of the radar of the FMCW scheme is to take measures against deception. Since many of conventional deception measures are made targeting pulse radars, the measures cannot be directly applied to the FMCW scheme. In addition, even if the conventional measures can be applied to FMCW, an advantage of FMCW which is low cost is lost.

An object of the present invention is to provide a radar of the FMCW scheme with measures against deception attacks.

### Solution to Problem

A radar apparatus that uses a frequency modulated continuous wave, the radar apparatus according to the present invention includes:

a random number generating unit to generate a random number sequence of one or more bits;

a local signal generating unit to generate a local signal according to a bit value of each bit of the random number sequence;

a transmitting unit to generate a transmit signal by frequency modulating a carrier wave with the local signal, and transmit the transmit signal;

a mixer to obtain the transmit signal from the transmitting unit, combine the transmit signal with a receive signal received by a receiving antenna, and output a mixer output signal;

a control filter to accept, as input, the mixer output signal and allow the mixer output signal to pass through the control filter according to a control signal;

a filter control unit to obtain the random number sequence from the random number generating unit, determine, using the random number sequence, a passing condition of at least one of a passing time period and a passing frequency band of the control filter, and output a signal indicating the passing conditions, as the control signal, to the control filter; and

an attack determining unit to obtain the random number sequence from the random number generating unit, and determine whether there is an attack, based on the random number sequence and an output signal outputted by the control filter according to the control signal.

### Advantageous Effects of Invention

By the present invention, a simple configuration that detects whether there is a deception attack can be provided to a radar of the FMCW scheme. By the present invention, an improvement in the reliability of the results of measurement by the radar and an improvement in the safety of a system using the radar can be achieved.

### BRIEF DESCRIPTION OF DRAWINGS

FIG. 1 is a diagram of a first embodiment and a configuration diagram of a radar 1 of a comparative example.

FIG. 2 is a diagram of the first embodiment and a timing chart of the radar 1.

FIG. 3 is a diagram of the first embodiment and a configuration diagram of a radar 1-1.

FIG. 4 is a diagram of the first embodiment and a configuration diagram of a computer 101.

FIG. 5 is a diagram of the first embodiment and a sequence diagram illustrating operation of the radar 1-1.

FIG. 6 is a diagram of the first embodiment and a flowchart illustrating operation of an attack determining unit 114.

FIG. 7 is a diagram of the first embodiment and a timing chart illustrating operation of the attack determining unit 114.

FIG. 8 is a diagram of the first embodiment and a flowchart illustrating operation of a local signal generating unit 111.

FIG. 9 is a diagram of the first embodiment and a timing chart illustrating operation of the attack determining unit 114 in relation to FIG. 8.

FIG. 10 is a diagram of the first embodiment and another timing chart illustrating operation of the attack determining unit 114 in relation to FIG. 8.

FIG. 11 is a diagram of the first embodiment and a flowchart illustrating operation of the local signal generating unit 111.

FIG. 12 is a diagram of the first embodiment and a timing chart illustrating operation of the attack determining unit 114 in relation to FIG. 11.

FIG. 13 is a diagram of the first embodiment and another timing chart illustrating operation of the attack determining unit 114 in relation to FIG. 11.

FIG. 14 is a diagram of the first embodiment and a flowchart illustrating operation of the local signal generating unit 111.

FIG. 15 is a diagram of the first embodiment and a timing chart illustrating operation of the attack determining unit 114 in relation to FIG. 14.

FIG. 16 is a diagram of the first embodiment and another timing chart illustrating operation of the attack determining unit 114 in relation to FIG. 14.

FIG. 17 is a diagram of the first embodiment and a flowchart illustrating operation of the local signal generating unit 111.

FIG. 18 is a diagram of the first embodiment and a timing chart illustrating operation of the attack determining unit 114 in relation to FIG. 17.

FIG. 19 is a diagram of the first embodiment and another timing chart illustrating operation of the attack determining unit 114 in relation to FIG. 17.

FIG. 20 is a diagram of the first embodiment and a configuration diagram of a radar 1-2.

FIG. 21 is a diagram of the first embodiment and a diagram illustrating operation of the radar 1-2.

FIG. 22 is a diagram of the first embodiment and a diagram illustrating an exemplary configuration of a time-frequency filter 210.

FIG. 23 is a diagram of the first embodiment and a diagram illustrating an exemplary configuration of a detector 220.

FIG. 24 is a diagram of the first embodiment and a diagram illustrating a processing circuit 99.

FIG. 25 is a diagram of a second embodiment and a configuration diagram of a control system 700.

FIG. 26 is a diagram of the second embodiment and a configuration diagram of a computer 600.

FIG. 27 is a diagram of the second embodiment and a flowchart illustrating operation of the computer 600.

### DESCRIPTION OF EMBODIMENTS

Embodiments of the present invention will be described below using the drawings. Note that in the drawings the same or corresponding portions are denoted by the same reference signs. In the description of the embodiments, description of the same or corresponding portions is omitted or simplified as appropriate.

In a first embodiment, as terms, a 1-bit random number which is a random number of one bit, and a random number sequence appear.

(1) Random numbers are data composed of one or more bits, and are random numbers in a general sense.

(2) A 1-bit random number is a random number of one bit.

(3) A random number sequence is a sequence generated by arranging one or more 1-bit random numbers. That is, the random number sequence is random numbers in a general sense. In addition, when the random number sequence is composed of only a single 1-bit random number, the random number sequence is the 1-bit random number itself.

### First Embodiment

Configuration of a Comparative Example

The present first embodiment relates to a radar apparatus 1-1 that uses FMCW. To clarify the features of the radar apparatus 1-1, first, a radar apparatus 1 will be described as a comparative example of the radar apparatus 1-1.

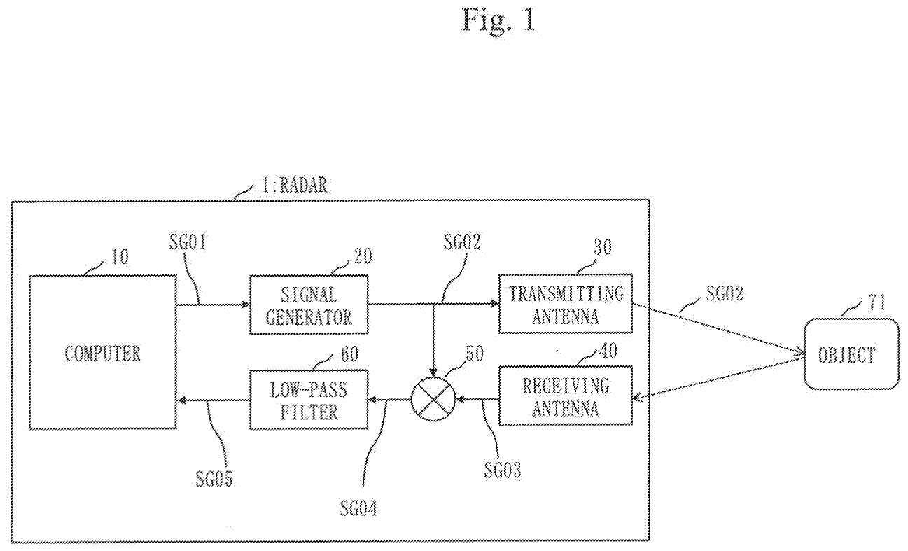

FIG. 1 is a configuration diagram of the radar apparatus 1. The radar apparatus 1 is also a radar apparatus that uses FMCW. The radar apparatus 1-1 and the radar apparatus 1 are hereinafter described as the radar 1-1 and radar 1. Using the radar 1 of FIG. 1, the operation of an FMCW scheme will be described. The radar 1 includes components such as a computer 10, a signal generator 20, a transmitting antenna 30, a receiving antenna 40, a mixer 50, and a low-pass filter 60. In addition, signals between the components are described as the local signal SG01, transmit signal SG02, receive signal SG03, mixer output signal SG04, and beat signal SG05.

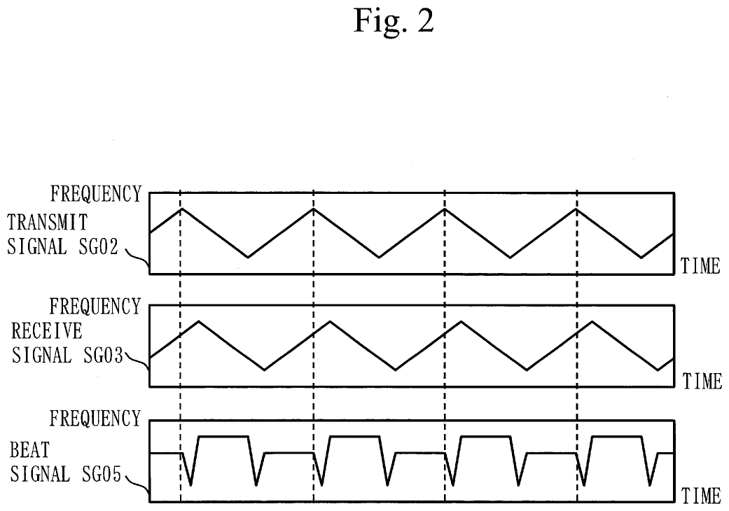

FIG. 2 is graphs schematically illustrating a transmit signal SG02, a receive signal SG03, and a beat signal SG05 in the radar 1 of FIG. 1. A horizontal axis of each graph is time and a vertical axis is frequency. FIG. 2 illustrates temporal changes in the frequency of each signal. A graph with time on the horizontal axis and frequency on the vertical axis such as those in FIG. 2 is hereinafter referred to as time-frequency graph. In the FMCW scheme, temporal changes in frequency are important and thus it is known that a signal is represented by a time-frequency graph.

Operation of the Radar 1 of the Comparative Example

As illustrated in FIG. 2, the frequency of the transmit signal SG02 changes like a triangle wave. The transmit signal SG02 is a signal obtained by frequency modulating a carrier wave with a local signal SG01 in the signal generator 20. The transmit signal SG02 is distributed to the transmitting antenna 30 and the mixer 50. The transmit signal SG02 is radiated into space from the transmitting antenna 30. The transmit signal SG02 is reflected by an object 71, and the reflected signal is detected by the receiving antenna 40. The signal detected by the receiving antenna 40 is a receive signal SG03. The receive signal SG03 has a signal waveform that is temporally delayed from the transmit signal SG02.

The receive signal SG03 is mixed with the transmit signal SG02 in the mixer 50. The mixer 50 outputs a mixer output signal SG04. The low-pass filter 60 extracts low-frequency components from the mixer output signal SG04 and thereby obtains a beat signal SG05. The beat signal SG05 has a value related to a difference in frequency between the transmit signal SG02 and the receive signal SG03 at a certain moment. Hence, by the computer 10 performing signal processing on the beat signal SG05, a relative distance or a relative velocity between the radar 1 and the object 71 or both can be calculated.

Configuration of the First Embodiment

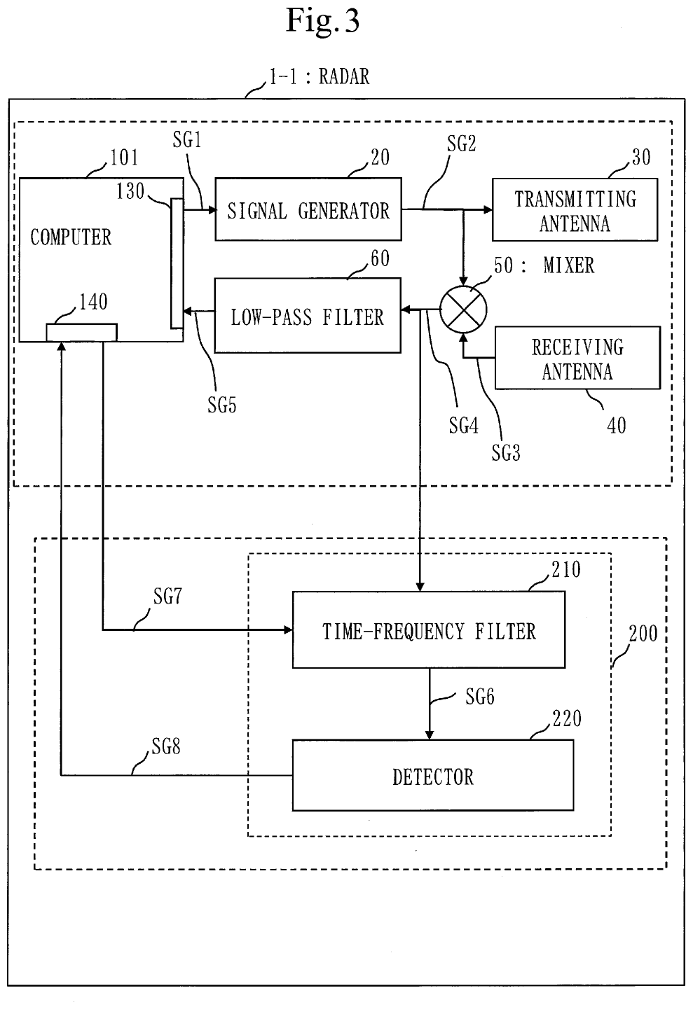

FIG. 3 illustrates a configuration of the radar 1-1 of the first embodiment. In FIG. 3, the object 71 illustrated in FIG. 1 is omitted. The radar 1-1 includes a computer 101, a signal generator 20, a transmitting antenna 30, a receiving antenna 40, a mixer 50, a low-pass filter 60, and a control filter 200. The control filter 200 includes a time-frequency filter 210 and a detector 220. For a hardware configuration, the radar 1-1 is configured such that the control filter 200 is added to the radar 1.

In the radar 1-1, signals between the components are described as the local signal SG1, transmit signal SG2, receive signal SG3, mixer output signal SG4, beat signal SG5, filter output signal SG6, filter control signal SG7, and detection signal SG8. The local signal SG1 is a signal generated by a local signal generating unit 111 to modulate a carrier wave. Though the details of the local signal SG1 will be described later in the description of the local signal generating unit 111, the local signal SG1 is generated from a periodic signal SG0 and a random number sequence. The computer 101 outputs the local signal SG1 to the signal generator 20.

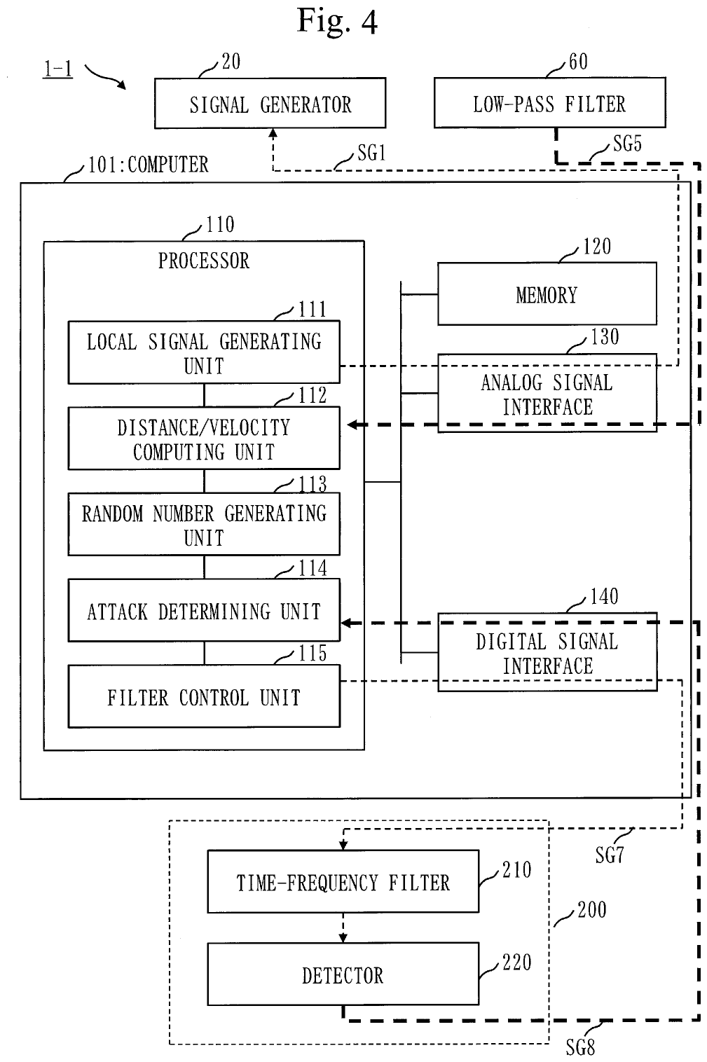

FIG. 4 illustrates a configuration of the computer 101. The computer 101 includes, as hardware, a processor 110, a memory 120, an analog signal interface 130, and a digital signal interface 140. In addition, the computer 101 includes, as a functional configuration, the local signal generating unit 111, a distance/velocity computing unit 112, a random number generating unit 113, an attack determining unit 114, and a filter control unit 115. The local signal generating unit 111, the distance/velocity computing unit 112, the random number generating unit 113, the attack determining unit 114, and the filter control unit 115 are implemented by software, specifically as follows. In the memory 120 is stored a program that implements the functions of the local signal generating unit 111, the distance/velocity computing unit 112, the random number generating unit 113, the attack determining unit 114, and the filter control unit 115. By the processor 110 reading and executing the program from the memory 120, the functions of the local signal generating unit 111, the distance/velocity computing unit 112, the random number generating unit 113, the attack determining unit 114, and the filter control unit 115 are implemented.

The analog signal interface 130 and the digital signal interface 140 are used to connect the computer 101 to external hardware, i.e., the signal generator 20, the low-pass filter 60, the time-frequency filter 210, and the detector 220. In an example illustrated in FIG. 3, the signal generator 20 and the low-pass filter 60 are analog devices, and the time-frequency filter 210 and the detector 220 are digital devices.

Description of Operation

The function of each component is as follows. The random number generating unit 113 generates a random number sequence. The local signal generating unit 111 generates a local signal SG1 according to the bit value of each bit of the random number sequence generated by the random number generating unit 113. The distance/velocity computing unit 112 computes a relative distance and a relative velocity between the radar 1-1 and the object 71, using a beat signal SG5. The attack determining unit 114 determines whether there is a deception attack, based on a detection signal SG8. The filter control unit 115 sets the time-frequency filter 210 through a filter control signal SG7.

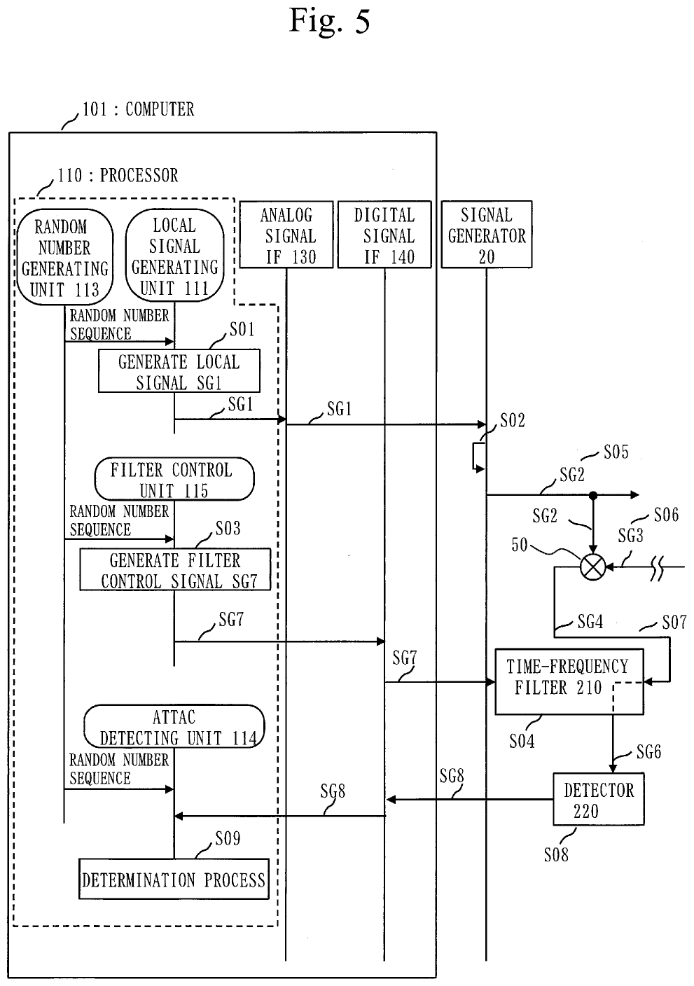

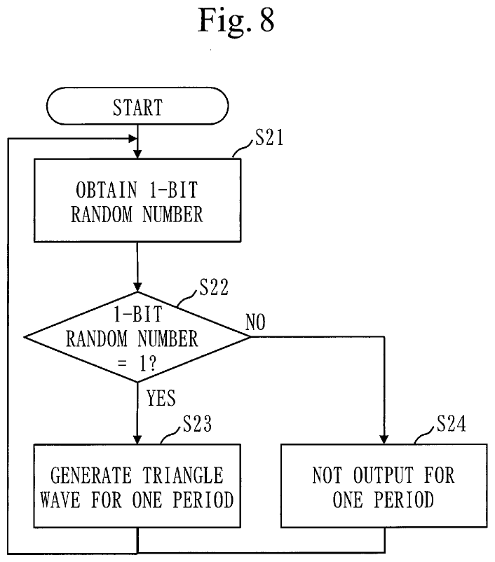

FIG. 5 is a sequence diagram describing the operation of the radar 1-1. With reference to FIG. 5, the operation of the radar 1-1 will be described. First, the random number generating unit 113 generates a random number sequence of one or more bits. At step S01, the local signal generating unit 111 generates a local signal, using the random number sequence generated by the random number generating unit 113. The local signal generating unit 111 generates the local signal SG1 according to the bit value of each bit of the random number sequence generated by the random number generating unit 113. Specifically, the local signal generating unit 111 associates a partial period which is at least a partial time period of one period of a periodic signal having periodicity, with one bit of the random number sequence, and generates, according to the bit value of one bit, a local signal from the waveforms of the partial periods with which one bit is associated. The details thereof will be described in a specific example of FIGS. 8 to 10. The local signal generating unit 111 transmits the local signal SG1 to the signal generator 20 through the analog signal interface 130.

At step S02, the signal generator 20 which is a transmitting unit 901 generates a transmit signal SG2 by frequency modulating a carrier wave with the local signal SG1, and the transmit signal SG2 is transmitted from the transmitting antenna 30.

At step S03, in parallel with step S01 to S02, the filter control unit 115 generates a filter control signal SG7, according to the random number sequence used to generate the local signal SG1 and a predetermined procedure. The predetermined procedure is stored in the memory 120. That is, the filter control unit 115 obtains the random number sequence used to generate the local signal SG1 from the random number generating unit 113, and determines, using the random number sequence, a passing condition of at least of a passing time period and a passing frequency band of the control filter 200. The filter control unit 115 outputs a signal that indicates the passing conditions, as the filter control signal SG7, to the control filter 200. The filter control signal SG7 is transmitted by the filter control unit 115 to the time-frequency filter 210 through the digital signal interface 140.

At step S04, the time-frequency filter 210 sets, using the filter control signal SG7, a time period or a frequency band during/in which a mixer output signal SG4 is allowed to pass therethrough, or both.

At step S05, the transmit signal SG2 is distributed to the transmitting antenna 30 and the mixer 50. The transmit signal SG2 is radiated into space from the transmitting antenna 30. The receiving antenna 40 detects a receive signal SG3, as with the radar 1.

At step S06, the receive signal SG3 is mixed with the transmit signal SG2 in the mixer 50. The mixer 50 outputs a mixer output signal SG4. The mixer 50 obtains the transmit signal SG2 from the signal generator 20, combines the transmit signal SG2 with the receive signal SG3 received by the receiving antenna 40, and outputs a mixer output signal SG4.

As illustrated in FIG. 3, the mixer output signal SG4 is distributed to the low-pass filter 60 and the time-frequency filter 210. Note that in FIG. 5 the low-pass filter 60 is omitted. The low-pass filter 60 extracts low-frequency components from the mixer output signal SG4 and thereby obtains a beat signal SG5. The distance/velocity computing unit 112 analyzes the beat signal SG5 and thereby calculates a relative distance or a relative velocity between the radar 1-1 and the object, or both.

At step S07, in the radar 1-1, the mixer output signal SG4 is inputted to the control filter 200 in parallel, and the mixer output signal SG4 is allowed to pass through according to the filter control signal SG7 which is a control signal. The time-frequency filter 210 extracts a filter output signal SG6 from the mixer output signal SG4. The detector 220 detects, from the filter output signal SG6, whether there is a signal having passed through the time-frequency filter 210, or the magnitude of the signal. At step S08, the detector 220 transmits a detection signal SG8 which is a result of the detection indicating whether there is a filter output signal SG6 or the amount of detection, to the attack determining unit 114 through the digital signal interface 140. At step S09, the attack determining unit 114 determines whether there is a deception attack, based on the random number sequence, the detection signal SG8, and a predetermined procedure. The deception attack is hereinafter described as the attack.

As such, the attack determining unit 114 obtains the random number sequence from the random number generating unit 113, and determines whether there is an attack, based on the random number sequence, the detection signal SG8 which is an output signal outputted by the control filter 200 according to the filter control signal SG7, and a predetermined procedure.

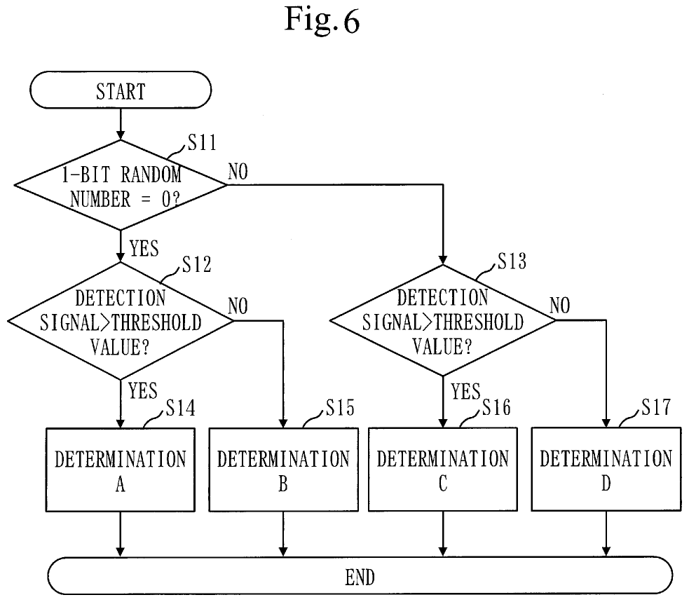

FIG. 6 is a flowchart for determining, by the attack determining unit 114, whether there is an attack. First, at step S11, conditional branching is performed by the value of a 1-bit random number. In addition, at step S12 and S13, conditional branching is performed according to the value of a detection signal SG8. As a result of the above, according to the value of the 1-bit random number and the value of the detection signal SG8, processing reaches any one of step S14, S15, S16, and S17. At step S14 to S17, the attack determining unit 114 determines whether there is an attack. The determination is referred to as determination A, determination B, determination C, and determination D.

Whether to assign “an attack is detected” and “an attack is not detected” to the determination A, the determination B, the determination C, and the determination D is set in a program as a predetermined procedure, according to a local signal SG1 generated using a random number sequence and the properties of the time-frequency filter 210.

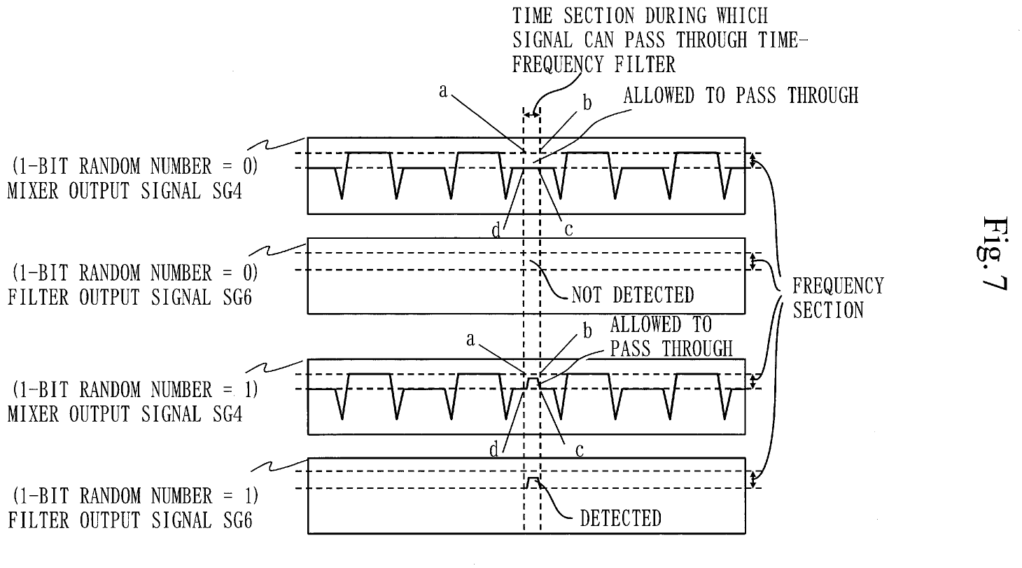

FIG. 7 is a diagram describing the assignment at step S14 to S17. FIG. 7 is time-frequency graphs, and illustrates a mixer output signal SG4 for a 1-bit random number being 0, a filter output signal SG6 for a 1-bit random number being 0, a mixer output signal SG4 for a 1-bit random number being 1, and a filter output signal SG6 for a 1-bit random number being 1.

In FIG. 7, regions at two locations each indicated by a rectangle abcd indicate a time period and a frequency band during/in which the time-frequency filter 210 allows a signal to pass therethrough. In an example of FIG. 7, a difference made according to the value of a 1-bit random number appears in the regions indicated by the rectangles abed of the mixer output signal SG4 (1-bit random number=0) and the mixer output signal SG4 (1-bit random number=1). As a result, whether passing of a signal appears in the filter output signal SG6 changes depending on the value of the 1-bit random number. Namely, in FIG. 7, when a 1-bit random number=0, the filter output signal SG6 with no detected signal is normal, and when a 1-bit random number=1, the filter output signal SG6 with a detected signal is normal. If “when a 1-bit random number=0, there is a detected signal” or “when a 1-bit random number=1, there is no detected signal”, then it is an abnormal situation and the attack determining unit 114 determines that there is an attack. When FIG. 7 is applied to the flowchart of FIG. 6, the determination A at step S14 is “there is an attack”, the determination B at step S15 is “there is no attack”, the determination C at step S16 is “there is no attack”, and the determination D at step S17 is “there is an attack”. Such content a predetermined procedure

Advantageous Effects of the First Embodiment

The radar 1-1 of the first embodiment generates a local signal SG1 based on a random number sequence, and generates a transmit signal SG2 using the local signal SG1. Thereafter, a signal component originating from a random number and included in a receive signal SG3 having been reflected and returned is extracted using the time-frequency filter 210, and an attack is detected from the extracted signal. By this, a distinction can be made between a deception signal emitted by an attacker that does not have a random number sequence and a receive signal SG3 originating from a transmit signal SG2 emitted by the radar 1-1. Therefore, there is an advantageous effect that the radar 1-1 can not only measure a distance and a velocity, but also detect an attack. In addition, due to a feature that extraction of a random-number component from a receive signal SG3 is performed only by the time-frequency filter 210 and the detector 220, the radar 1-1 can be implemented only by adding a very small amount of hardware to a general FMCW radar. Thus, there is an advantageous effect that measures against attacks can be taken while suppressing cost. In addition, it becomes possible to alert a user about the presence of an attacker, or to selectively discard deceived measurement data.

Examples of some generation schemes for a local signal SG1 will be described below.

First Generation Scheme

In a first generation scheme for a local signal SG1, a triangle wave is generated as a periodic signal SG0, and whether to generate a triangle wave for one period is changed according to the bit value of each 1-bit random number of a random number sequence, by which a local signal SG1 is generated.

FIG. 8 is a flowchart illustrating a procedure of the first generation scheme for a local signal SG1 by the local signal generating unit 111. In the first generation scheme, two values, 0 and 1, are used as 1-bit random numbers. First, at step S21, the local signal generating unit 111 obtains a 1-bit random number which is one bit among a random number sequence obtained from the random number generating unit 113. For example, the local signal generating unit 111 obtains a 1-bit random number in turn from the most significant bit to the least significant bit in the random number sequence. The same also applies to each generation scheme illustrated below. If the bit value of the obtained 1-bit random number is 1 (YES at step S22), the local signal generating unit 111 outputs one period of a triangle wave (step S23). If the bit value of the 1-bit random number is 0 (NO at step S22), the local signal generating unit 111 does not output a triangle wave for one period, as a local signal SG1 (step S24).

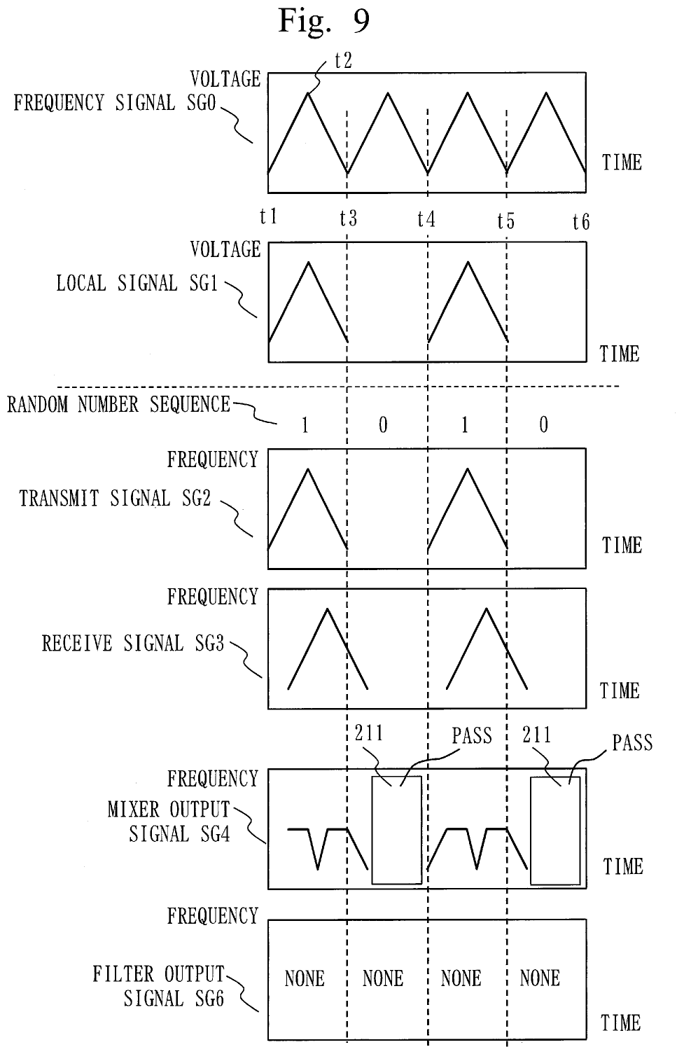

In FIG. 9, two graphs at the top illustrate a periodic signal SG0 and a local signal SG1. The vertical axes of the periodic signal SG0 and the local signal SG1 are voltage, and the horizontal axes are time. Four graphs at the bottom are all time-frequency graphs.

The local signal generating unit 111 associates a partial period which is at least a partial time period of one period of the periodic signal SG0 having periodicity, with a 1-bit random number of a random number sequence, and generates, according to the bit value of a 1-bit random number, a local signal from the waveforms of the partial periods with which a 1-bit random number is associated. The periodic signal SG0 is a signal, based on which the local signal SG1 is generated.

The local signal generating unit 111 generates the local signal SG1 illustrated in the second row of FIG. 9. However, for a periodic signal SG0, the local signal generating unit 111 may or may not generate a periodic signal SG0. In the case of generating a periodic signal SG0, the local signal generating unit 111 generates a periodic signal SG0 and thereafter generates a local signal SG1 from the periodic signal SG0, according to each bit value of a 1-bit random number of a random number sequence. In the case of generating a local signal SG1 without generating a periodic signal SG0, for example, the local signal generating unit 111 holds a periodic signal SG0 as a function expression, and can generate a local signal SG1 from the function expression of the periodic signal SG0 and a random number sequence. In the first to fourth generation schemes described below, description is made of a case in which the local signal generating unit 111 generates a periodic signal SG0. Note that as described prior to describing the first embodiment, a random number sequence may be of one or more bits.

The local signal generating unit 111 generates a triangle wave as a periodic signal SG0, and associates a partial period which is at least a partial time period of one period of the triangle wave, with a 1-bit random number of a random number sequence. The partial period may be one period. In FIG. 9, a 1-bit random number is associated with one period of a unit triangle wave whose one period starts from a base (time t1), passes through a vertex (time t2), and ends at a next base (time t3). In FIG. 9, the partial period is one period of a unit triangle wave. The local signal generating unit 111 associates each partial period with each 1-bit random number of the random number sequence. In FIG. 9, the local signal generating unit 111 associates partial periods from time t1 to time t3, from time t3 to time t4, from time t4 to time t5, and from time t5 to time t6, with 1-bit random numbers, 1, 0, 1, and 0, forming the random number sequence.

In the case of the first generation scheme, the local signal generating unit 111 stops the output of a unit triangle wave according to the bit value of a 1-bit random number. In generation of the local signal SG1 of FIG. 9, when a 1-bit random number of the random number sequence is 1, the local signal generating unit 111 generates a triangle wave of one period as a local signal SG1, and when a 1-bit random number of the random number sequence is 0, the local signal generating unit 111 does not generate a triangle wave of one period.

Four graphs at the bottom of FIG. 9 are a transmit signal SG2, a receive signal SG3, a mixer output signal SG4, and a filter output signal SG6. FIG. 9 illustrates a case of no attack.

The transmit signal SG2 has a shape corresponding to the local signal SG1. In sections of the transmit signal SG2 in which a 1-bit random number is 1, a beat signal SG5 to be obtained matches a beat signal of the radar 1 of the comparative example. Hence, by appropriately cutting out portions of the beat signal SG5 corresponding to the transmit signal SG2 and performing signal processing on the portions, as with the radar 1 of the comparative example, a distance and a velocity can be sensed. The time-frequency filter 210 is “pass” only in a part of a section with a 1-bit random number of 0 which is indicated by a rectangle 211 in FIG. 9. In the mixer output signal SG4 for a case of no attack, there is no signal included in the regions of the rectangles 211, and thus, as a result, there is no filter output signal SG6 at all times.

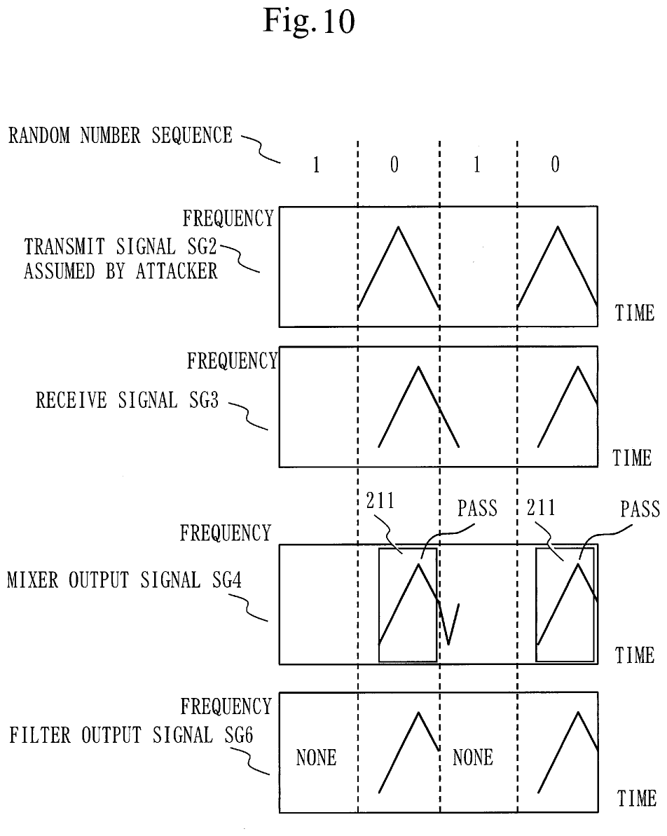

FIG. 10 illustrates each signal for a case of an attack. Since an attacker cannot predict a random number sequence, a deception signal that cannot occur under normal circumstances is outputted in sections in which a 1-bit random number of a random number sequence is 0 in FIG. 10. That is a transmit signal SG2 assumed by the attacker. The transmit signal SG2 appears in a mixer output signal SG4 through a receive signal SG3. As a result, the mixer output signal SG4 appears in sections indicated by rectangles 211 in which the time-frequency filter 210 is “pass”. Namely, in the sections with a 1-bit random number of 0, detection of a filter output signal SG6 by the detector 220 is “detected”. Hence, the attack determining unit 114 can determine that there is an attack, by the presence of the filter output signal SG6 in the sections with a 1-bit random number of 0.

Second Generation Scheme

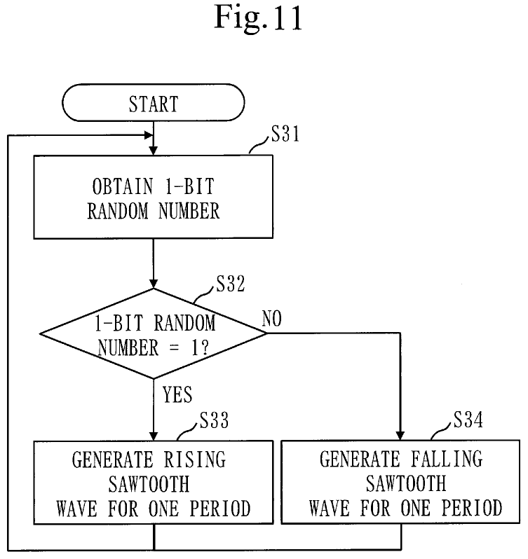

With reference to FIGS. 11, 12, and 13, a second generation scheme for a local signal SG1 will be described. In the second generation scheme, a sawtooth wave is generated as a periodic signal SG0, and the ups and downs of the sawtooth wave are changed according to a random number sequence, by which a local signal SG1 is generated. Other points are the same as those of the first generation scheme.

FIG. 11 is a flowchart illustrating a procedure of generating a local signal SG1 in the local signal generating unit 111. At step S31, the local signal generating unit 111 obtains a 1-bit random number from a random number sequence. If the 1-bit random number is 1 (YES at step S32), the local signal generating unit 111 outputs a rising sawtooth wave for one period (step S33). If the 1-bit random number is 0 (NO at step S32), the local signal generating unit 111 outputs a falling sawtooth wave for one period (step S34).

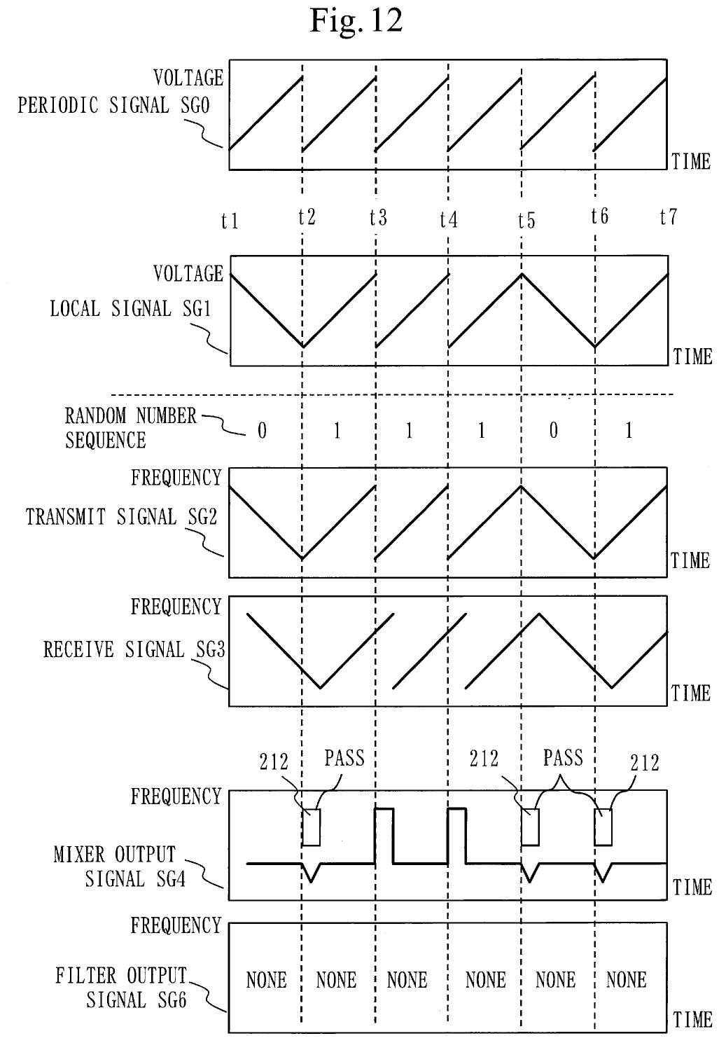

In FIG. 12, two graphs at the top illustrate a periodic signal SG0 and a local signal SG1. The vertical axes of the periodic signal SG0 and the local signal SG1 are voltage, and the horizontal axes are time. Four graphs at the bottom are all time-frequency graphs. In the second generation scheme, a sawtooth wave is the periodic signal SG0.

The local signal generating unit 111 generates a sawtooth wave as the periodic signal SG0, and associates each 1-bit random number of a random number sequence with a partial period. In the second generation scheme, the partial period is from time t1 to time t2 in the periodic signal SG0 of FIG. 12. That is, one period of the sawtooth wave is a partial period. In FIG. 12, the local signal generating unit 111 associates 1-bit random numbers of the random number sequence with a partial period from time t1 to time t2, a partial period from time t2 to time t3, a partial period from time t3 to time t4, a partial period from time t4 to time t5, a partial period from time t5 to time t6, and a partial period from time t6 to time t7. When the bit value of a 1-bit random number is 0, the local signal generating unit 111 generates, as a local signal SG1, a sawtooth wave in decrease shape that decreases with the passage of time, based on the shape of an increase time period of the sawtooth wave (one period of the sawtooth wave). The sawtooth wave in decrease shape and the shape of the increase time period are symmetrical with respect to the vertical axis. When the bit value of a 1-bit random number is 1, the local signal generating unit 111 generates, based on the shape of an increase time period of the sawtooth wave (one period of the sawtooth wave), a local signal SG1 in the shape of the increase time period of the sawtooth wave as it is.

Four at the bottom of FIG. 12 are a transmit signal SG2, a receive signal SG3, a mixer output signal SG4, and a filter output signal SG6. FIG. 12 illustrates a case of no attack. The transmit signal SG2 partially matches a transmit signal of the radar 1. Hence, by appropriately cutting out corresponding portions of a beat signal SG5 and performing signal processing on the portions, as with the radar 1, a distance and a velocity can be sensed. The time-frequency filter 210 is “pass” only in a section in which a 1-bit random number changes from 0 to 1 or from 1 to 0 and which is indicated by a rectangle 212 in FIG. 12. In the mixer output signal SG4 for a case of no attack, there is no signal included in the regions of the rectangles 212, and thus, as a result, there is no filter output signal SG6 at all times.

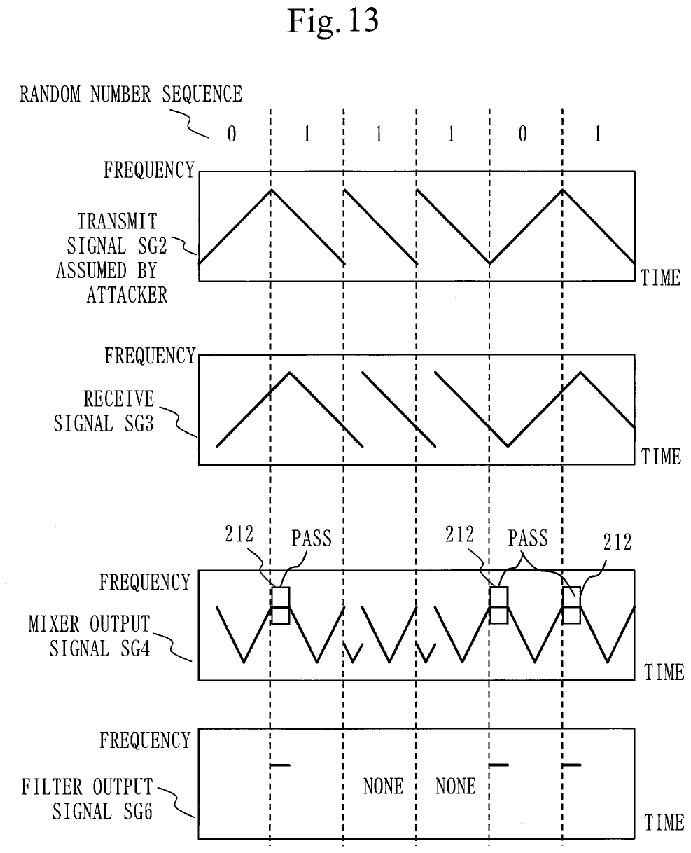

FIG. 13 illustrates each signal for a case of an attack. Since an attacker cannot predict a random number sequence, a deception signal is outputted in which the ups and downs of a sawtooth wave are reversed and which cannot occur under normal circumstances. That is a transmit signal SG2 assumed by the attacker. The transmit signal SG2 appears in a mixer output signal SG4 through a receive signal SG3. As a result, the mixer output signal SG4 is valid in sections which are indicated by rectangles 212 and in which the time-frequency filter 210 is “pass”. Namely, in a section in which a 1-bit random number transitions from 0 to 1 or from 1 to 0, a filter output signal SG6 is observed by the detector 220. Hence, the attack determining unit 114 can determine that there is an attack, by the presence of the filter output signal SG6 in the section.

Note that in the second generation scheme, whether the time-frequency filter 210 is “pass” or “block” changes by two bits which are consecutive 1-bit random numbers. Hence, the condition at step S11 which is conditional branching of FIG. 6 in detection needs to be such a condition that “whether the value of a 1-bit random number differs from the value of a 1-bit random number immediately therebefore”.

Third Generation Scheme

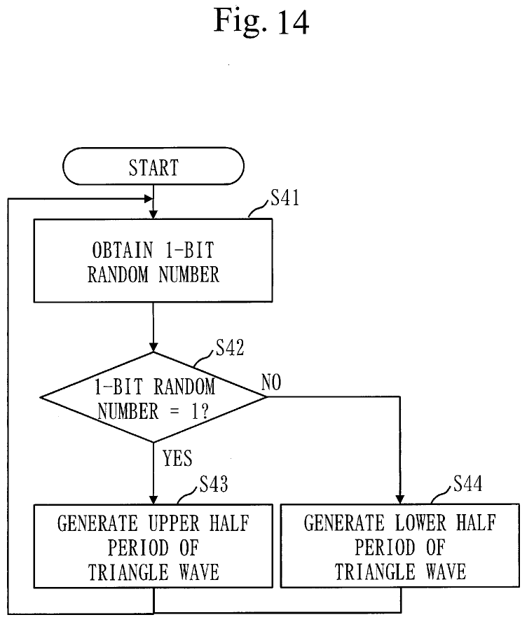

With reference to FIGS. 14, 15, and 16, a third generation scheme for a local signal SG1 will be described. In the third generation scheme, a triangle wave is generated as a periodic signal SG0. In the third generation scheme, the upper half or lower half of the triangle wave is generated as a local signal SG1, according to the value of a 1-bit random number of a random number sequence. Other points are the same as those of the first generation scheme.

FIG. 14 is a flowchart illustrating a procedure of generating a local signal SG1 in the local signal generating unit 111. In the third generation scheme, two values, 0 and 1, are used as 1-bit random numbers. First, at step S41, the local signal generating unit 111 obtains a 1-bit random number. If the 1-bit random number is 1 (YES at step S42), the local signal generating unit 111 outputs an upper half period of a triangle wave (step S43). If the 1-bit random number is 0 (NO at step S42), the local signal generating unit 111 outputs a lower half period of a triangle wave (step S44).

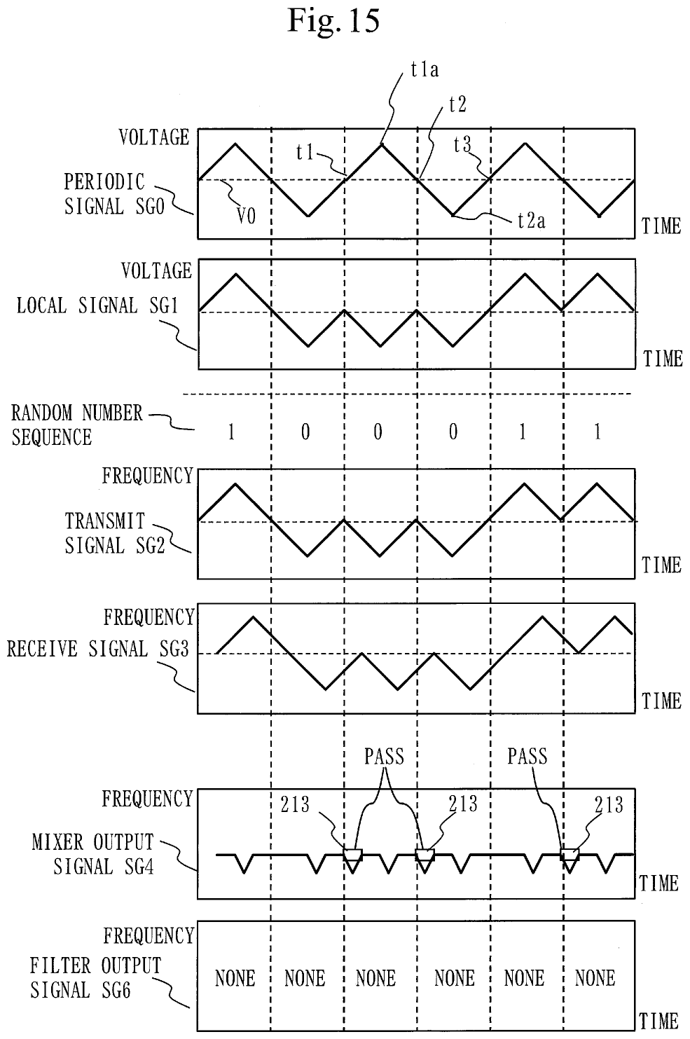

In FIG. 15, two graphs at the top illustrate a periodic signal SG0 and a local signal SG1. The vertical axes of the periodic signal SG0 and the local signal SG1 are voltage, and the horizontal axes are time. Four graphs at the bottom are all time-frequency graphs.

In the third generation scheme, for one period of a triangle wave, in FIG. 15, a time period from time t1 to time t3 is one period. The periodic signal SG0 is a triangle wave. In the triangle wave, one period includes an upward triangle wave with an upward projection that starts from a median value V0 in the middle between maximum and minimum amplitudes (time t1), passes through a vertex (time t1a), and returns to the median value V0 (time t2); and a downward triangle wave with a downward projection that is followed by the upward triangle wave, and starts from the median value V0 (time t2), passes through a base (time t2a), and returns to the median value V0 (time t3). A partial period is each half period of one period. A time period from time t1 to time t2, a time period from time t2 to time t3, etc., are partial periods. In FIG. 15, the local signal generating unit 111 associates each 1-bit random number of a random number sequence with each partial period of the periodic signal SG0. When the bit value of a 1-bit random number is 0, the local signal generating unit 111 generates a downward triangle wave as a local signal SG1, and when the bit value of a 1-bit random number is 1, the local signal generating unit 111 generates an upward triangle wave as a local signal SG1. Note that an upward triangle wave may be generated when the bit value is 0, and a downward triangle wave may be generated when the bit value is 1.

Four graphs at the bottom of FIG. 15 are a transmit signal SG2, a receive signal SG3, a mixer output signal SG4, and a filter output signal SG6. FIG. 15 illustrates a case of no attack. The transmit signal SG2 partially matches a transmit signal of the radar 1. Hence, by appropriately cutting out portions of a beat signal SG5 corresponding to the transmit signal SG2 and performing signal processing on the portions, as with the radar 1, a distance and a velocity can be sensed. The time-frequency filter 210 is “pass” only in a section in which a 1-bit random number continues from 0 to 0 or from 1 to 1 and which is indicated by a rectangle 213 in FIG. 15. In the mixer output signal SG4 for a case of no attack, there is no signal included in the regions of the rectangles 213, and as a result, there is no filter output signal SG6 at all times.

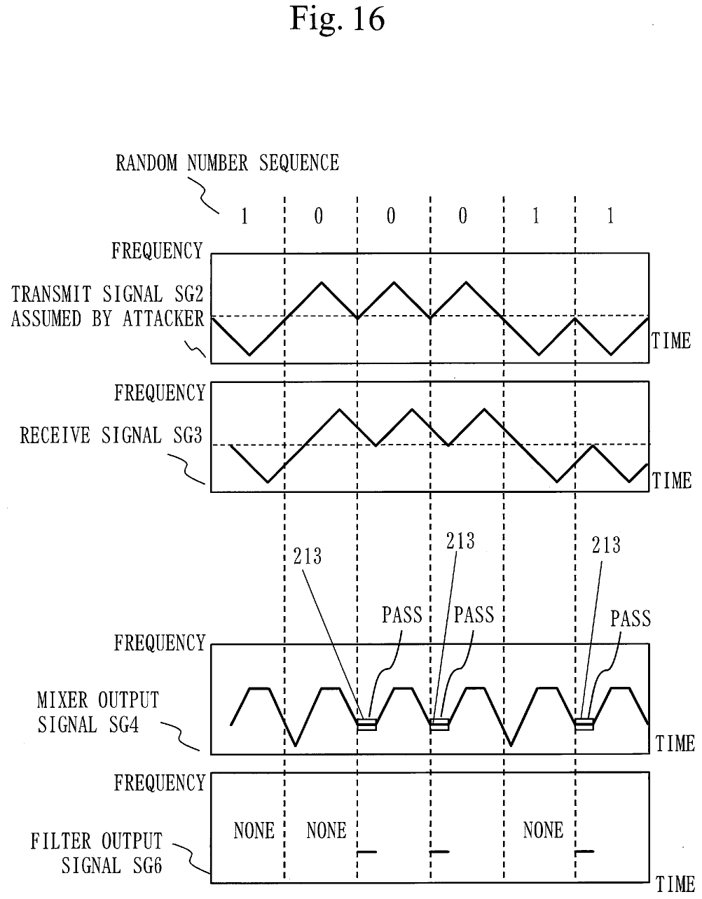

FIG. 16 illustrates each signal for a case of an attack. Since an attacker cannot predict 1-bit random numbers, a deception signal is outputted in which the upper half and lower half of a triangle wave are reversed and which cannot occur under normal circumstances. That is a transmit signal SG2 assumed by the attacker. The transmit signal SG2 appears in a mixer output signal SG4 through a receive signal SG3. As a result, the mixer output signal SG4 is valid in sections which are indicated by rectangles 213 and in which the time-frequency filter 210 is “pass”. Namely, in a section in which a 1-bit random number transitions from 0 to 0 or from 1 to 1, a filter output signal SG6 is detected by the detector 220. Hence, the attack determining unit 114 can determine that there is an attack, by the presence of the filter output signal SG6 in the section.

Note that in the third generation scheme, the passing and blocking of the time-frequency filter 210 change by two bits which are consecutive 1-bit random numbers. Hence, the condition at step S11 which is conditional branching of FIG. 6 in detection needs to be such a condition that “whether the value of a 1-bit random number is the same as the value of a 1-bit random number immediately therebefore”.

Fourth Generation Scheme

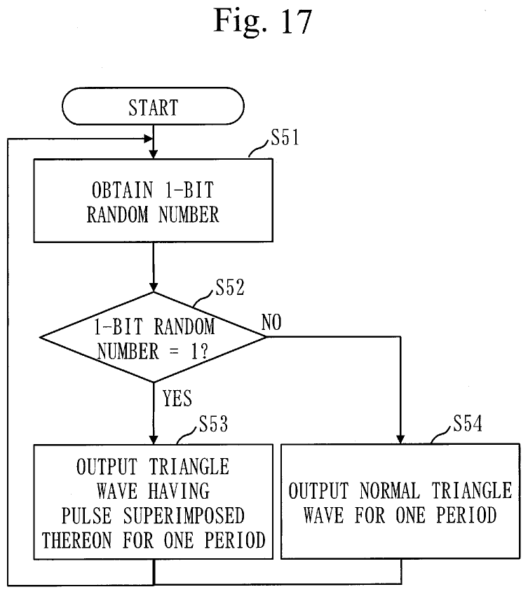

With reference to FIGS. 17, 18, and 19, a fourth generation scheme will be described. In the fourth generation scheme, a triangle wave is generated as a periodic signal SG0, and pulses are superimposed on the triangle wave according to a random number sequence, by which a local signal SG1 is generated. Other points are the same as those of the first generation scheme.

FIG. 17 is a flowchart illustrating a procedure of generating a local signal SG1 in the local signal generating unit 111. In the fourth generation scheme, two values, 0 and 1, are used as 1-bit random numbers. First, at step S51, the local signal generating unit 111 obtains a 1-bit random number. If the 1-bit random number is 1 (YES at step S52), the local signal generating unit 111 superimposes a pulse on a triangle wave (step S53). If the 1-bit random number is 0 (NO at step S52), a triangle wave is outputted as it is (step S54).

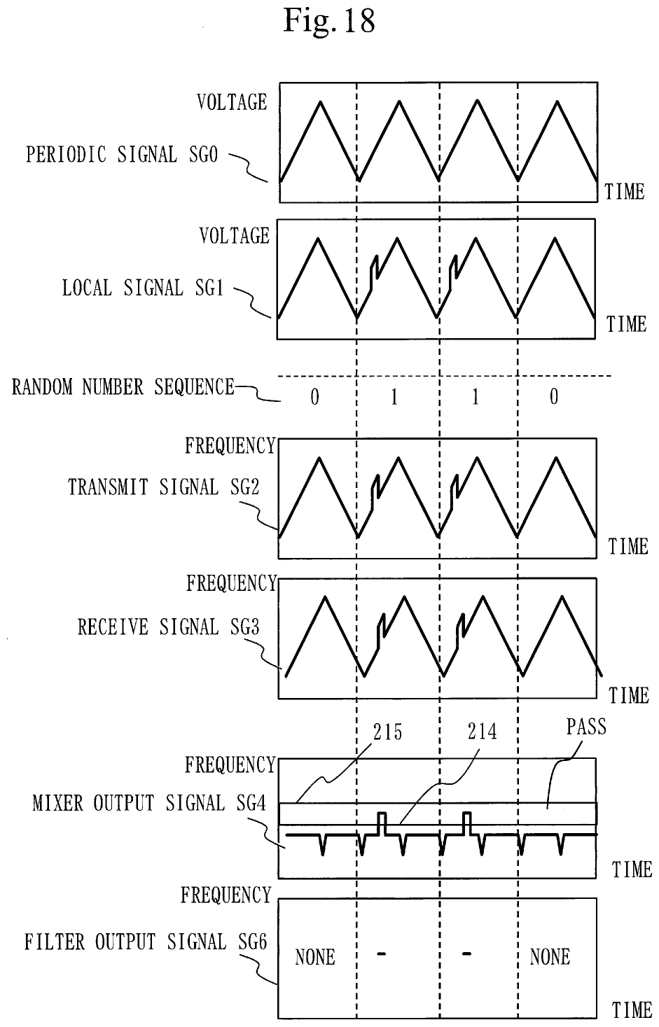

In FIG. 18, two graphs at the top illustrate a periodic signal SG0 and a local signal SG1. The vertical axes of the periodic signal SG0 and the local signal SG1 are voltage, and the horizontal axes are time. Four at the bottom are all time-frequency graphs.

In the fourth generation scheme, one period and a partial period of a triangle wave is the same as those of the first generation scheme. In FIG. 18, the local signal generating unit 111 associates each 1-bit random number of a random number sequence with each partial period of the periodic signal SG0. When the bit value of a 1-bit random number is 0, the local signal generating unit 111 generates a unit triangle wave as a local signal SG1 without superimposing a pulse on the unit triangle wave, and when the bit value of a 1-bit random number is 1, the local signal generating unit 111 superimposes a pulse on a unit triangle wave and thereby generates the unit triangle wave having the pulse superimposed thereon as a local signal SG1.

Four graphs at the bottom of FIG. 18 are a transmit signal SG2, a receive signal SG3, a mixer output signal SG4, and a filter output signal SG6. FIG. 18 illustrates a case of no attack. The transmit signal SG2 partially matches a transmit signal of the radar 1. Hence, by appropriately cutting out portions of a beat signal SG5 corresponding to the transmit signal SG2 and performing signal processing on the portions, as with the radar 1, a distance and a velocity can be sensed. The time-frequency filter 210 is “pass” only in a high-frequency portion present in a range between a horizontal line 214 and a horizontal line 215 in FIG. 18. Only when a pulse is superimposed on a triangle wave, a cut-off frequency at which the mixer output signal SG4 can pass through the time-frequency filter 210 is selected by a filter control signal SG7. Hence, the filter output signal SG6 is “detected” only in a section with a 1-bit random number of 1 in which there is pulse superimposition.

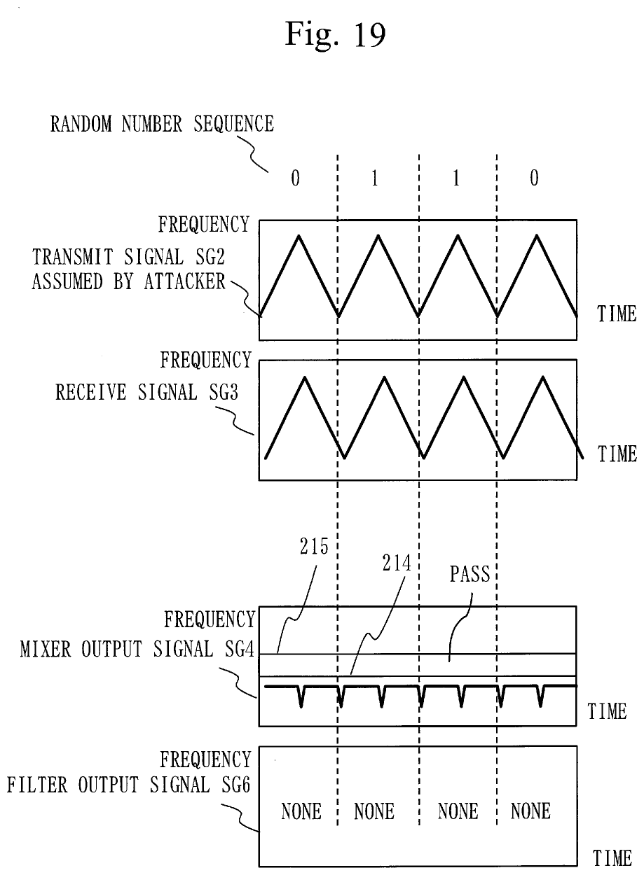

FIG. 19 illustrates each signal for a case of an attack. Since an attacker cannot predict 1-bit random numbers, a triangle wave with no pulse superimposition is outputted at locations where pulses are supposed to be superimposed. That is a transmit signal SG2 assumed by the attacker. The transmit signal SG2 appears in a mixer output signal SG4 through a receive signal SG3. As a result, even in a section with a 1-bit random number of 1, a filter output signal SG6 is “not detected”. Hence, the attack determining unit 114 can determine that there is an attack, by the absence of the filter output signal SG6 in a section with a 1-bit random number of 1.

Note that although a triangle wave is illustrated as the periodic signal SG0, the periodic signal SG0 may be a sawtooth wave or may be any other periodic signal.

Two or More Types of Filters and Combination of Results Thereof

Although the radar 1-1 illustrated in FIG. 3 uses only one control filter 200 including the time-frequency filter 210 and the detector 220, a plurality of control filters 200 may be used.

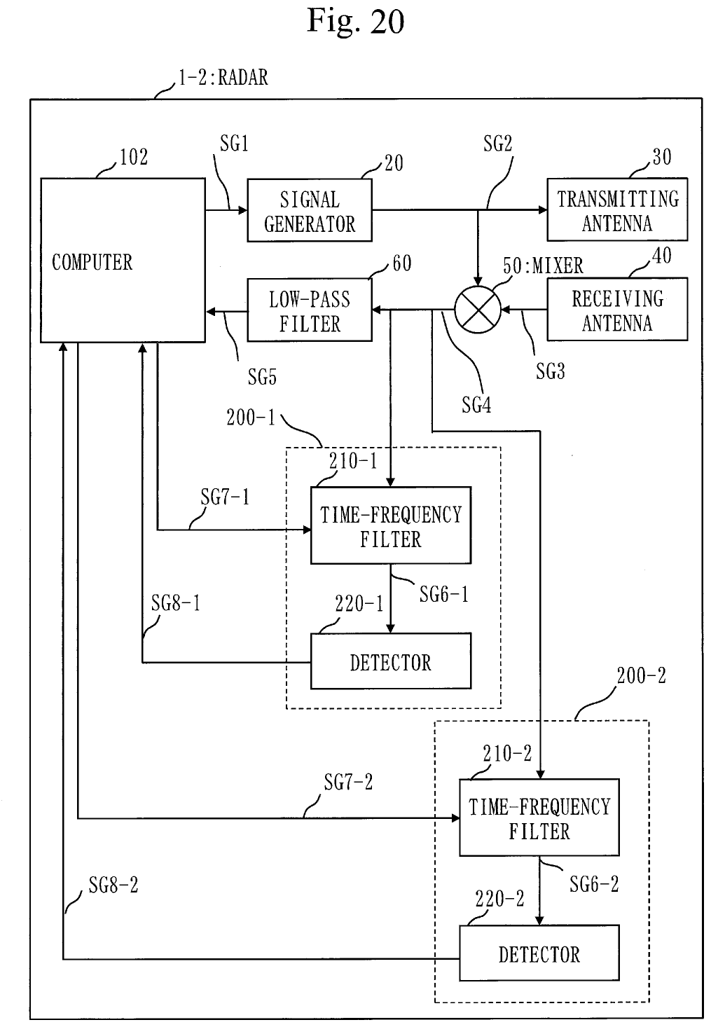

FIG. 20 illustrates a configuration of a radar 1-2. The radar 1-2 uses two control filters, a first control filter 200-1 and a second control control filter 200-2. The first control filter 200-1 includes a time-frequency filter 210-1 and a detector 220-1, and the second control filter 200-2 includes a time-frequency filter 210-2 and a detector 220-2. The time-frequency filter 210-1 and the time-frequency filter 210-2 have different pass characteristics. By complimentarily using the time-frequency filter 210-1 and the time-frequency filter 210-2 having different pass characteristics, as a result, the detection performance of attacks improves. Specifically, the filter control unit 115 outputs a first control signal SG7-1 which is a filter control signal SG7 used by the first control filter 200-1, to the first control filter 200-1, and outputs a second control signal SG7-2 which is a filter control signal SG7 used by the second control filter 200-2, to the second control filter 200-2.

Utilization Method Using Two Types of Filters

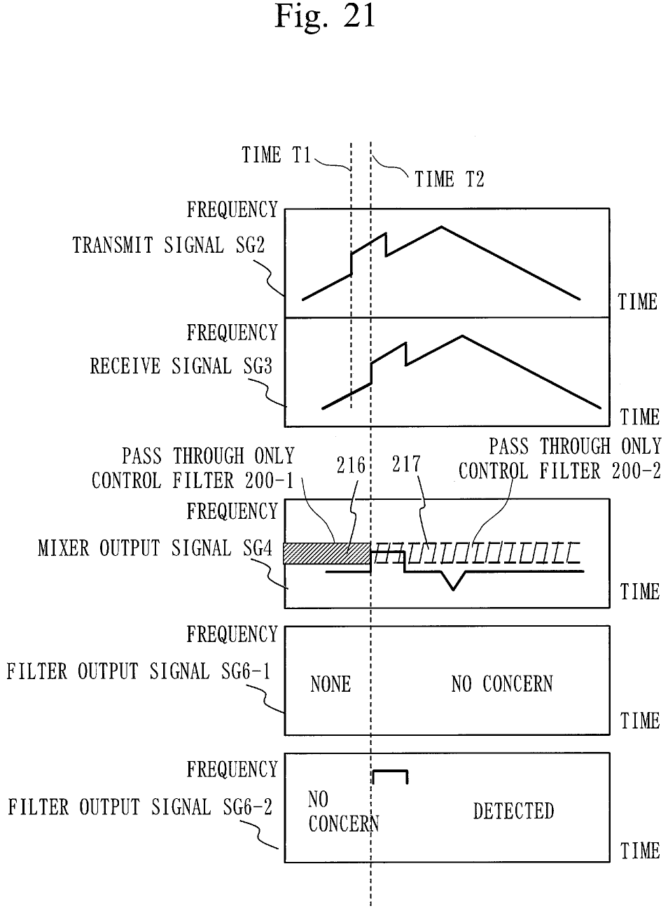

A specific utilization method that utilizes the first control filter 200-1 and the second control filter 200-2 that have different pass characteristics will be described below. Using the first control filter 200-1 and the second control filter 200-2, occurrence timing of a receive signal is measured. This measurement method will be described using FIG. 21.

FIG. 21 is time-frequency graphs. In FIG. 21, the first control signal SG7-1 indicates a passing time period of the first control filter 200-1, and the second control signal SG7-2 indicates a passing time period of the second control filter 200-2 which is different than the passing time period of the first control filter 200-1.

As a transmit signal SG2, as in the case of FIG. 18, a triangle wave having pulses superimposed thereon is assumed. In addition, it is assumed that a pulse that appears in the transmit signal SG2 at time T1 of FIG. 21 arrives at a receive signal SG3 at time T2.

In a time-frequency graph of a mixer output signal SG4, a range 216 and a range 217 are indicated by two types of hatching. The range 216 and the range 217 indicate the pass characteristics of the time-frequency filter 210-1 and the time-frequency filter 210-2. The time-frequency filter 210-1 allows a signal in the range 216 before time T2 to pass therethrough, and blocks a signal after time T2. On the other hand, the time-frequency filter 210-2 blocks a signal before time T2, and allows a signal in the range 217 after time T2 to pass therethrough.

In FIG. 21, a filter output signal SG6-1 of the time-frequency filter 210-1 and a filter output signal SG6-2 of the time-frequency 210-2 are represented by time-frequency graphs.

When there is no attack, the following operation is assumed. The filter output signal SG6-1 of the time-frequency filter 210-1 is “not detected”. On the other hand, the filter output signal SG6-2 of the time-frequency filter 210-2 is “detected”. The following unexpected operation is an abnormal situation and is determined to be an attack. That is, the filter output signal SG6-1 is “detected” or the filter output signal SG6-2 is “not detected”.

By using two complementary control filters as described above, not only the fact that a pulse provided to a local signal SG1 which is not illustrated has been transmitted to the mixer output signal SG4, but also the fact that the pulse has arrived at assumed time can be verified. By the verification of pulse arrival time, resistance to a high-level attack that generates a deception signal during a narrow time section such as a time period from time T1 to time T2 can be obtained.

Special Example of Attack Determination

An attacker may attack by randomly estimating the values of 1-bit random numbers. The probability of success in the estimation of 1-bit random numbers is ½. When the same detection is repeated n times, the probability of success in all estimation by the attacker decreases to (½) to the nth power. Using that property, a plurality of detections may be repeated, and only when a predetermined degree of accuracy is obtained, it may be determined that there is detection. That is, the attack determining unit 114 may repeat the process of determining an attack of FIG. 6 a plurality of times, and detect that there is an attack from results of the repetition. As such, the attack determining unit 114 determines whether there is an attack, by using the results of a plurality of determinations.

Special Example of the Time-Frequency Filter 210

The time-frequency filter 210 can be configured such that a gate 211a that controls only a time at which a signal passes through is cascade-connected to a band-pass filter 212a that controls only a frequency band.

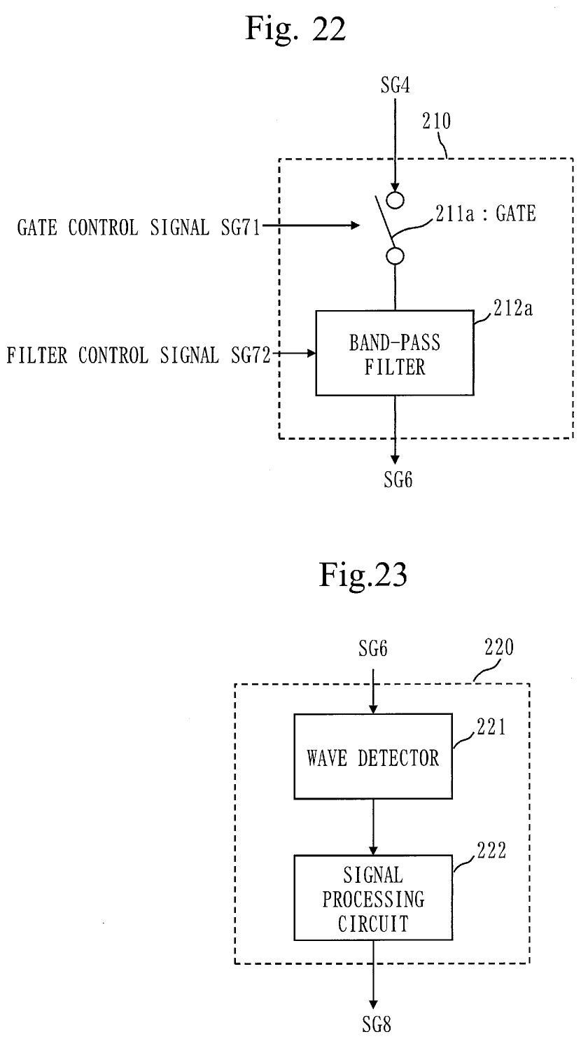

FIG. 22 is a diagram in which the time-frequency filter 210 is composed of the gate 211a and the band-pass filter 212a. The time-frequency filter 210 is implemented by a cascade connection of the gate 211a and the band-pass filter 212a. A gate control signal SG71 controls the gate 211a, and a filter control signal SG72 controls the band-pass filter 212a. The gate control signal SG71 and the filter control signal SG72 are a filter control signal SG7.

The gate 211a opens and closes by the gate control signal SG71. As a result, a time filter can be implemented that allows only a mixer output signal SG4 arriving at a specific time to pass therethrough. The band-pass filter 212a allows only a signal in a specific frequency band to pass therethrough. A band-pass filter 212a that can change a passing frequency by the filter control signal SG72 may be used. As described above, by combining the gate 211a with the band-pass filter 212a, the time-frequency filter 210 can be implemented. As such, the time-frequency filter 210 in the control filter 200 includes the gate 211a capable of controlling a passing time period by an electrical signal; and the band-pass filter 212a capable of controlling a frequency band by a different electrical signal than the electrical signal used for the gate 211a.

Special Example of the Time-Frequency Filter

In the computer 101, the filter control unit 115 may generate a filter control signal SG7 using measurement information including at least either one of a distance and a velocity computed by the distance/velocity computing unit 112, specifically as follows. The computation distance/velocity computing unit 112 which is a computing unit 902 computes measurement information including at least either one of the distance to the object 71 and the velocity of the measurement target, based on a mixer output signal SG4. The filter control unit 115 determines a filter control signal SG7 which is passing conditions, using the measurement information computed by the computation distance/velocity computing unit 112.

Special Example of the Detector

FIG. 23 illustrates an exemplary configuration of the detector 220. As illustrated in FIG. 23, the detector 220 can be configured such that a wave detector 221 that checks whether there is a wave is cascade-connected to a signal processing circuit 222 at a subsequent stage. Particularly, as the signal processing circuit 222, for example, an integrator, a peak-hold circuit, a filter circuit, or the like, may be used.

Special Example of a Reaction Method

When the distance/velocity computing unit 112 computes a distance or a velocity, the distance/velocity computing unit 112 may use a result of determination by the attack determining unit 114. As an example, the distance/velocity computing unit 112 may perform a process of discarding a portion of a beat signal SG5 corresponding to a time period during which it is determined that there is an attack, specifically as follows. In the radar apparatus 1-1, the computation distance/velocity computing unit 112 which is the computing unit 902 obtains a result of determination from the attack determining unit 114, and computes measurement information including at least either one of the distance to the object 71 and the velocity of the measurement target, based on a mixer output signal SG4. The computation distance/velocity computing unit 112 determines whether to keep or discard the measurement information, using the obtained result of determination.

Special Example Regarding the Distance/Velocity Computing Unit 112

When the distance/velocity computing unit 112 computes the distance or velocity of the object 71, the distance/velocity computing unit 112 may correct a beat signal by a predetermined method, according to whether a 1-bit random number is 0 or 1, specifically as follows. In the radar 1-1, the low-pass filter 60 which is a beat signal generating unit 903 accepts, as input, a mixer output signal SG4, generates a beat signal SG5 from the mixer output signal SG4, and outputs the beat signal SG5. The distance/velocity computing unit 112 which is the computing unit 902 accepts, as input, the beat signal SG5 from the low-pass filter 60, obtains a random number sequence from the random number generating unit 113, and corrects the beat signal SG5 using the obtained random number sequence. The distance/velocity computing unit 112 computes measurement information including at least either one of the distance to a measurement target and the velocity of the measurement target, using the corrected beat signal SG5.

Other Configurations

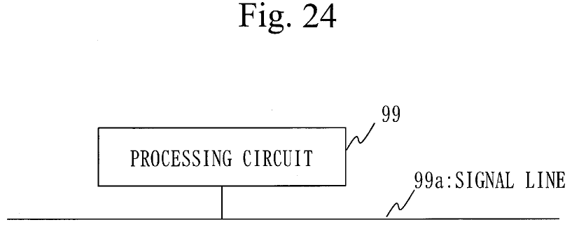

FIG. 24 is a diagram illustrating a processing circuit 99. In the present embodiment, the functions of the local signal generating unit 111, the distance/velocity computing unit 112, the random number generating unit 113, the attack determining unit 114, and the filter control unit 115 are implemented by software. However, as a modified example, the functions of the local signal generating unit 111, the distance/velocity computing unit 112, the random number generating unit 113, the attack determining unit 114, and the filter control unit 115 may be implemented by hardware. That is, the functions of the local signal generating unit 111, the distance/velocity computing unit 112, the random number generating unit 113, the attack determining unit 114, and the filter control unit 115 which are illustrated as the aforementioned processor 110 and the memory 120 are implemented by the processing circuit 99. The processing circuit 99 is connected to a signal line 99a. The processing circuit 99 is an electronic circuit. The processing circuit 99 is specifically a single circuit, a combined circuit, a programmed processor, a parallel programmed processor, a logic IC, a gate array (GA), an application specific integrated circuit (ASIC), or a field-programmable gate array (FPGA).

As another modified example, the functions of the local signal generating unit 111, the distance/velocity computing unit 112, the random number generating unit 113, the attack determining unit 114, the filter control unit 115, and the memory 120 may be implemented by a combination of software and hardware. The processor 110, the memory 120, and the processing circuit 99 are collectively referred to as “processing circuity”. The functions of the local signal generating unit 111, the distance/velocity computing unit 112, the random number generating unit 113, the attack determining unit 114, the filter control unit 115, and the memory 120 are implemented by the processing circuitry. Note that the operation of the radar 1-1 can also be grasped as an attack detection method.

Configuration of a Second Embodiment

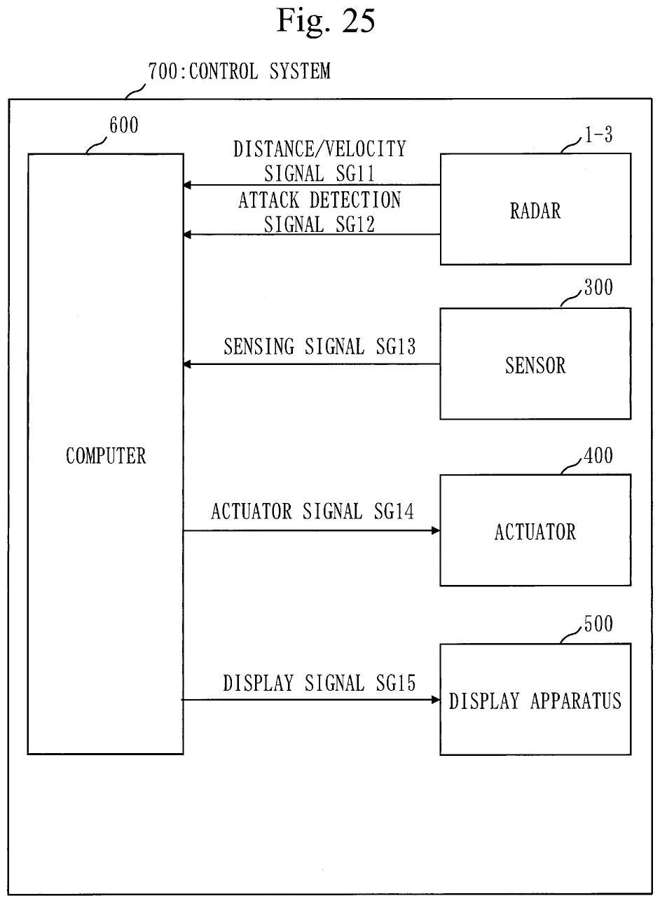

FIG. 25 illustrates a configuration of a control system 700 of a second embodiment. The control system 700 of the second embodiment includes a radar 1-3, a sensor 300, an actuator 400, a display apparatus 500, and a computer 600. The radar 1-3 is the radar 1-1 or the radar 1-2 of the first embodiment. The control system 700 can be applied to a wide range of sensor systems or actuator systems that involve measurement of a distance or a velocity by the radar 1-3. Applications include, for example, automatic driving or driving assistance for automobiles, agricultural machinery, robots, and the like.

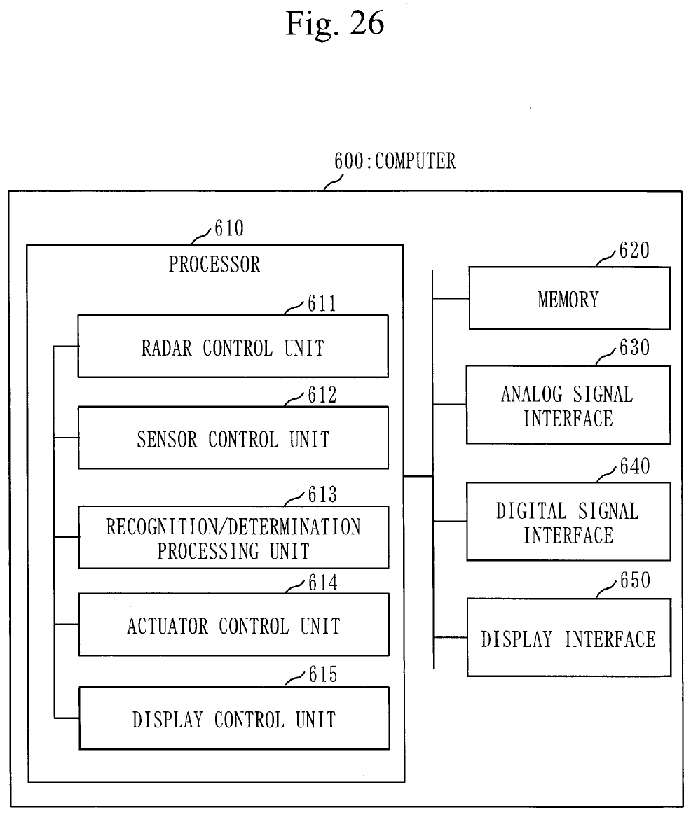

A configuration of the computer 600 will be described using FIG. 26.

FIG. 26 is a configuration diagram of the computer 600. The computer 600 includes, as hardware, a processor 610, a memory 620, an analog signal interface 630, a digital signal interface 640, and a display interface 650. In addition, the computer 600 has, as a functional configuration, a radar control unit 611, a sensor control unit 612, a recognition/determination processing unit 613, an actuator control unit 614, and a display control unit 615.

The radar control unit 611, the sensor control unit 612, the recognition/determination processing unit 613, the actuator control unit 614, and the display control unit 615 are implemented as a program. The program is stored in the memory 620. The program is read and executed by the processor 401. The analog signal interface 630 and the digital signal interface 640 are used to communicate between the computer 600 and the radar 1-3, the sensor 300, and the actuator 400. The display interface 650 is used to communicate between the computer 600 and the display apparatus 500.

Operation of the Control System 700

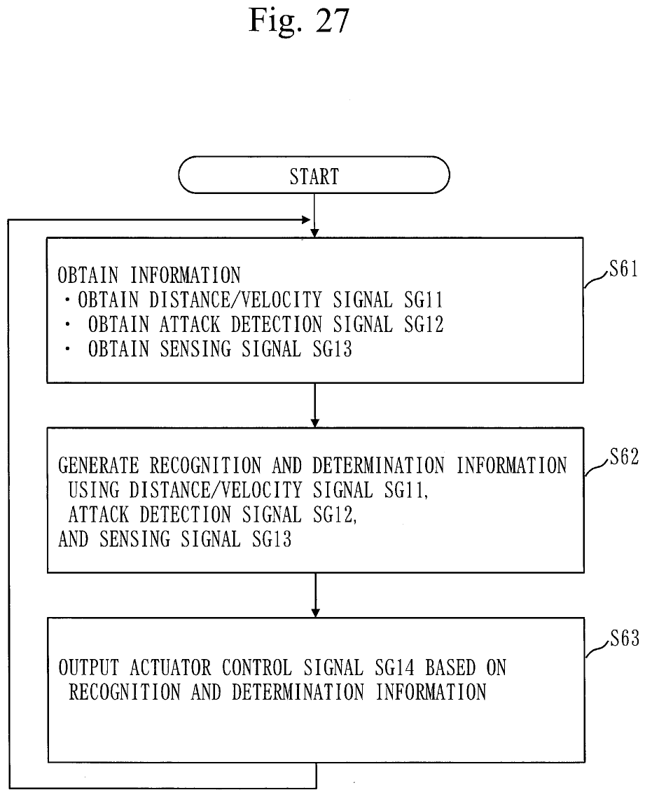

FIG. 27 is a flowchart illustrating the operation of the control system 700. The operation of the control system 700 will be described using FIG. 27. First, at step S61, the computer 600 obtains information. More specifically, the radar control unit 611 obtains a distance/velocity signal SG11 and an attack detection signal SG12 from the radar 1-3. The distance/velocity signal SG11 is outputted by the distance/velocity computing unit 112. The distance/velocity signal SG11 is a signal indicating the distance between the object 71 and the radar and the relative velocity of the object 71 which are computed by the distance/velocity computing unit 112. The attack detection signal SG12 is outputted by the attack determining unit 114. The attack detection signal SG12 is a signal indicating, by the attack determining unit 114, detection of an attack. The sensor control unit 611 obtains a sensing signal SG13 from the sensor 300. The sensing signal SG13 is a signal indicating a result of detection by the sensor 300. At step S62, the authentication/determination processing unit 613 performs recognition and determination using the distance/velocity signal SG11, the attack detection signal SG12, and the sensing signal SG13. At step S63, the actuator control unit 614 outputs an actuator control signal SG14 that controls the actuator 400, to the actuator 400 based on results of the recognition and determination at step S62. By repeating the above-described step S61 to S63, the computer 600 can implement automatic operation or autonomous operation which is performed by controlling the actuator 400.

Advantageous Effects of the Second Embodiment

By using the attack detection signal SG12 obtained by the radar 1-3, the recognition or determination at step S63 becomes robust against an attack.

As reaction taken when the attack detection signal SG12 indicates the presence of an attack, the following operation (1) to (4) can be performed:

(1) continue operation using only information of the sensor 300;

(2) transition to a safety stop;

(3) transition to degraded mode in which only a minimum function is provided;

(4) alert the user through the display control unit 615, the display interface 650, and the display apparatus 500;

etc.

### REFERENCE SIGNS LIST

SG0: periodic signal, SG01 and SG1: local signal, SG02 and SG2: transmit signal, SG03 and SG3: receive signal, SG04 and SG4: mixer output signal, SG05 and SG5: beat signal, SG6: filter output signal, SG7: filter control signal, SG7-1: first control signal, SG7-2: second control signal, SG8: detection signal, SG11: distance/velocity signal, SG12: attack detection signal, SG13: sensing signal, SG14: actuator control signal, 1, 1-1, 1-2, and 1-3: radar, 10: computer, 20: signal generator, 30: transmitting antenna, 40: receiving antenna, 50: mixer, 60: low-pass filter, 71: object, 101 and 102: computer, 110: processor, 111: local signal generating unit, 112: distance/velocity computing unit, 113: random number generating unit, 114: attack determining unit, 115: filter control unit, 120: memory, 130: analog signal interface, 140: digital signal interface, 200: control filter, 200-1: first control filter, 200-2: second control filter, 210: time-frequency filter, 211a: gate, 212a: band-pass filter, 211, 212, and 213: rectangle, 214 and 215: horizontal line, 216 and 217: range, 220: detector, 221: wave detector, 222: signal processing circuit, 300: sensor, 400: actuator, 500: display apparatus, 600: computer, 610: processor, 620: memory, 630: analog signal interface, 640: digital signal interface, 650: display interface, 700: control system, 901: transmitting unit, 902: computing unit, 903: beat signal generating unit.

1-15. (canceled)

16. A radar apparatus that uses a frequency modulated continuous wave, the radar apparatus comprising:
processing circuitry to:
generate a random number sequence of one or more bits, and
generate a local signal according to a bit value of each bit of the random number sequence;
a transmitter to generate a transmit signal by frequency modulating a carrier wave with the local signal, and transmit the transmit signal;
a mixer to obtain the transmit signal from the transmitter, combine the transmit signal with a receive signal received by a receiving antenna, and output a mixer output signal; and
a control filter to accept, as input, the mixer output signal and allow the mixer output signal to pass through the control filter according to a control signal;
the processing circuitry further to:
obtain the random number sequence, determine, using the random number sequence, a passing condition of at least one of a passing time period and a passing frequency band of the control filter, and output a signal indicating the passing condition, as the control signal, to the control filter; and
obtain the random number sequence, and determine whether there is an attack, based on the random number sequence and an output signal outputted by the control filter according to the control signal.

17. The radar apparatus according to claim 16, wherein the processing circuitry associates a partial period with one bit of the random number sequence and generates, according to a bit value of the one bit, the local signal from a waveform of the partial period with which the one bit is associated, the partial period being at least a partial time period of one period of a periodic signal having periodicity.

18. The radar apparatus according to claim 17, wherein the periodic signal is either one of a triangle wave and a sawtooth wave.

19. The radar apparatus according to claim 18, wherein:
the periodic signal is the triangle wave;
the one period starts from a base, passes through a vertex, and ends at a next base of the triangle wave; and
the partial period is the one period.

20. The radar apparatus according to claim 18, wherein:
the periodic signal is the triangle wave;
the one period includes an upward triangle wave with an upward projection and a downward triangle wave with a downward projection of the triangle wave, the upward triangle wave starting from a median value in middle between a maximum amplitude and a minimum amplitude, passing through a vertex, and returning to the median value; and the downward triangle wave being followed by the upward triangle wave, and starting from the median value, passing through a base, and returning to the median value; and
the partial period is each half period of the one period.

21. The radar apparatus according to claim 17, wherein the processing circuitry generates the local signal by superimposing, according to the bit value of the one bit, a pulse wave on the waveform of the partial period with which the one bit is associated.

22. The radar apparatus according to claim 16, comprising at least a first control filter and a second control filter as the control filter,
wherein the processing circuitry:
outputs a first control signal to the first control filter, the first control signal being the control signal used by the first control filter, and
outputs a second control signal to the second control filter, the second control signal being the control signal used by the second control filter.

23. The radar apparatus according to claim 22, wherein
the first control signal indicates a passing time period of the first control filter, and
the second control signal indicates a passing time period of the second control filter, the passing time period being different than the passing time period of the first control filter.

24. The radar apparatus according to claim 16, wherein the processing circuitry determines whether there is an attack, using results of a plurality of determinations.

25. The radar apparatus according to claim 16, wherein the control filter includes a gate capable of controlling the passing time period by an electrical signal; and a band-pass filter capable of controlling the passing frequency band by a different electrical signal than the electrical signal used for the gate.

26. The radar apparatus according to claim 16,
wherein the processing circuitry:
computes measurement information based on the mixer output signal, the measurement information including at least either one of a distance to a measurement target and a velocity of the measurement target; and
determines the passing condition using the measurement information computed.

27. The radar apparatus according to claim 16, wherein the processing circuitry obtains a result of the determination, computes measurement information based on the mixer output signal, and determines whether to keep or discard the measurement information, using the result of the determination, the measurement information including at least either one of a distance to a measurement target and a velocity of the measurement target.

28. The radar apparatus according to claim 16, further comprising a low-pass filter to accept, as input, the mixer output signal, generate a beat signal from the mixer output signal, and output the beat signal;
wherein the processing circuitry accepts, as input, the beat signal, obtains the random number sequence, corrects the beat signal using the random number sequence, and computes measurement information using the corrected beat signal, the measurement information including at least either one of a distance to a measurement target and a velocity of the measurement target.

29. The radar apparatus according to claim 16, wherein the control filter includes a wave detector and a signal processing circuit.

30. A control system comprising:
a radar apparatus according to claim 16;
a sensor;
an actuator; and
a computer to control the actuator, using a measured value of the sensor and a measured value of the radar apparatus.
